(19) United States
(12) Patent Application Publication
(10) Pub. No.: US 2022/0379217 A1
(43) Pub. Date: Dec. 1, 2022

(54) Non-Player Character Artificial Intelligence

(71) Applicant: Human Mode, L.L.C., Oklahoma City, OK (US)

(72) Inventors: Chi Kim Kerber, Oklahoma City, OK (US); William Xavier Kerber, Oklahoma City, OK (US)

(73) Assignee: Human Mode, L.L.C., Oklahoma City, OK (US)

(21) Appl. No.: 17/828,675

(22) Filed: May 31, 2022

Related U.S. Application Data
(60) Provisional application No. 63/194,784, filed on May 28, 2021.

(51) Int. Cl. A63F 13/55; A63F 13/49; B25J 9/16; B25J 19/02; G06N 3/00; G06N 3/02

(52) U.S. Cl. CPC A63F 13/55; A63F 13/49; B25J 9/161; B25J 19/02; G06N 3/006; G06N 3/02

(57) ABSTRACT

This invention relates generally to a software-enabled, computer-implemented neural processing system for a non-player character (NPC) in a computer-enabled virtual environment. The system includes a plurality of virtual sensors configured to detect one or more virtual stimuli presented by the virtual environment to the NPC and present corresponding stimuli detection signals in response to the one or more virtual stimuli. The neural processing system may also include a virtual neo cortex, which may include a plurality of processing modules that are each configured to process stimuli detection signals output from the plurality of virtual sensors. The neural processing system also may include a virtual thalamus module configured to receive the stimuli detection signals and transmit the stimuli detection signals to the appropriate processing modules of the virtual neo cortex.

### RELATED APPLICATIONS

This application claims the benefit of U.S. Provisional Patent Application Ser. No. 63/194,784 filed May 28, 2021 entitled, “Non-Player Character Artificial Intelligence,” the disclosure of which is herein incorporated by reference.

### FIELD OF INVENTION

The present invention relates generally to the field of artificial intelligence, and more particularly, but not by way of limitation, to systems and methods for using artificial intelligence and machine learning for generating, controlling and optimizing non-player characters in video games and robots.

### BACKGROUND OF INVENTION

An important aspect of video games and simulated environments is the user or player's interactions with Non-Player-Characters (or “NPCs”). NPCs are important to most games because they can serve as “opponents” or “allies” and enhance game play for a human player. Often, NPCs are deployed as antagonists and are used to move the game story forward. Modern video games tend to rely less on NPCs as the primary opponent due to the limitations in programmed behavior of the NPCs. Instead, game developers often choose to build “multi-player online” games which allow live humans to face each other online. Multiplayer games are sometimes preferred because game play and player interaction is less predictable than in games that rely heavily on conventional NPCs. NPCs used in current video games are generally limited to a few types such as: (1) reflexive agents that are pre-programmed to respond to the recognizable states of the environment without reasoning; and (2) learning agents that are able to modify their performance with respect to some task based on user interaction.

The behaviors of existing NPC learning agent are generally controlled by forcing the NPC learning agent to maximize a particular calculated value. For instance, the Monte Carlo Search Tree algorithm uses random trials to solve a problem. For each move in a game, the NPC first considers all the possible moves it could make, then it consider all the possible moves the player character could make in response, then it consider all its possible responding moves, and so on. After repeating this iterative process multiple times, the NPC would calculate the move with the best turnout. This calculation could be based on a value which leads the NPC to winning the game. These types of NPCs can easily defeat users in many games with a sufficient amount of computational power. These types of NPCs are often too smart to create an enjoyable, organic user experience.

NPC reflexive agents, on the other hand, often employ some variation of a finite state machine approach. In a finite state machine, a designer generalizes all possible situations that an NPC could encounter, and then programs a specific reaction for each situation. A finite state machine NPC reacts to the player character's action with its pre-programmed behavior. For example, in a shooting game, the NPC would attack when the player character shows up and then retreat when its own health level is too low.

NPCs in games generally rely on very rudimentary techniques for user interaction. Although impressive, existing platforms are not suitable to be used as NPCs in simulated environments and games for a number of reasons. First, the life-span of the particular NPC is limited to the running game in which the NPC was launched. Existing NPCs do not learn, change or evolve from one game to the next. Each time the game is played the NPC is launched with a refreshed memory that omits any acquired learning from past sessions. Second, NPCs aren't provided with life-like goals. Most prior art NPCs have been assigned goals like finding the player and defeating them or dealing damage. Prior art NPCs are devoid of deeper, more organic drivers. Third, the NPCs are not unique. Prior art NPCs are programmed with very little room for variance between game sessions. Existing NPC programs exhibit very predictable in-game behavior.

In light of the deficiencies in the prior art, there remains a need for improved NPC behavior and interaction with users. It is to these and other deficiencies in the prior art that the present invention is directed.

### SUMMARY OF THE INVENTION

In one embodiment, the present disclosure is directed to a software-enabled, computer-implemented neural processing system for a non-player character (NPC) in a computer-enabled virtual environment. The neural processing system includes a plurality of virtual sensors. Each of the plurality of virtual sensors is configured to detect one or more virtual stimuli presented by the virtual environment to the NPC and present corresponding stimuli detection signals in response to the one or more virtual stimuli. The neural processing system also includes a virtual neo cortex. The virtual neo cortex includes a plurality of processing modules that each configured to process stimuli detection signals output from the plurality of virtual sensors. The neural processing system also includes a virtual thalamus module configured to receive the stimuli detection signals and transmit the stimuli detection signals to the appropriate processing modules of the virtual neo cortex.

In another aspect, the present disclosure is directed to a software-enabled, computer-implemented method for controlling an adaptive non-player character (NPC) program in a computer-enabled video game environment. The software-enabled method includes the steps of spawning the adaptive NPC with a series of character traits, moving the spawned adaptive NPC to an existence server, connecting the adaptive NPC from the existence server to a first game session within the video game environment, modifying the adaptive NPC in response to a stimulus from the first game session to produce a modified adaptive NPC, terminating the first game session while maintaining the modified adaptive NPC in a persistent state within the existence server, and connecting the modified adaptive NPC from the existence server to a second game session within the video game environment.

In yet another embodiment, the present disclosure is directed to a software-enabled neural processing system for a physical robot. In this embodiment, the neural processing system includes a plurality of sensors. Each of the plurality of virtual sensors is configured to detect one or more stimuli presented by to the robot from an environment surrounding the robot, and present corresponding stimuli detection signals in response to the one or more stimuli. The neural processing system also includes a software-enabled artificial neo cortex that includes a plurality of processing modules that each configured to process stimuli detection signals output from the plurality of sensors. The neural processing system further includes a software-enabled artificial thalamus module configured to receive the stimuli detection signals and transmit the stimuli detection signals to the appropriate processing modules of the artificial neo cortex.

### BRIEF DESCRIPTION OF DRAWINGS

FIG. 1 is a process flowchart of an AI service, existence service, and client interface 120 with interactions between them.

FIG. 2 is a process flowchart showing an embodiment of the process for NPC creation by the AI service.

FIG. 3 is a process flowchart that provides an overview of the interaction between the NPC existence service and the NPC client interface.

FIG. 4 is a graphical depiction of a concept with two sensory elements and a time component.

FIG. 5 is a graphical depiction showing an embodiment of an NPC hierarchical system of concept storage.

FIG. 6 is a graphical depiction showing an NPC hierarchical system of concept storage prior to processing a set of sensory inputs.

FIG. 7 is a graphical depiction showing an NPC hierarchical system of concept storage processing sensory inputs to a concept and into short term memory.

FIG. 8 is a graphical depiction showing an NPC hierarchical system of concept storage prior with a new concept meeting the stored concept threshold and moving into long term memory.

FIG. 9 is a process flowchart showing an overview of an embodiment of how an NPC processes sensory inputs.

FIG. 10 is a process flowchart showing a first embodiment of an NPC brain, associated modules and sensory inputs.

FIG. 11 is a process flowchart showing a second embodiment of an NPC brain, associated modules and sensory inputs.

### WRITTEN DESCRIPTION

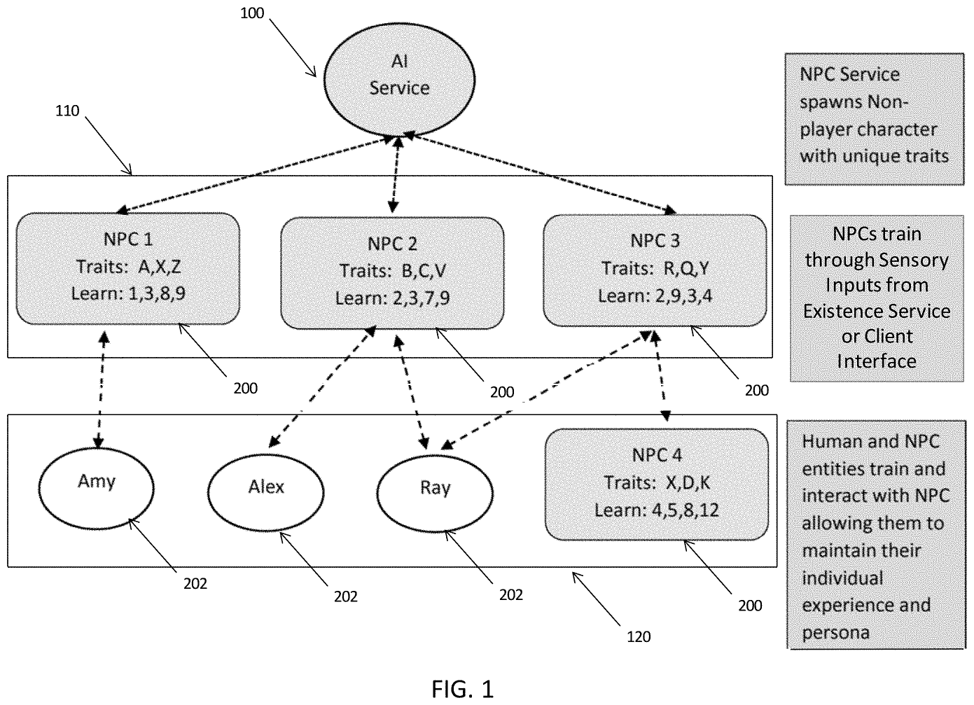

Beginning with FIG. 1, shown there is a process flowchart of the AI service 100, existence service 110, and client interface 120. Generally, the AI service 100 (also referred to herein as the “NPC Service”) is a computer-implemented program that creates one or more NPC programs 200 (each an “NPC 200”), that can be hosted on a networked infrastructure or other appropriate hosting means. The hosting infrastructure can be remote, as in an internet hosted service, or local across a local network. The NPCs 200 are configured to engage with the client interface 120, which may be a video game or other virtual environment in which users 202 and other NPCs are permitted to interact with the NPCs 200.

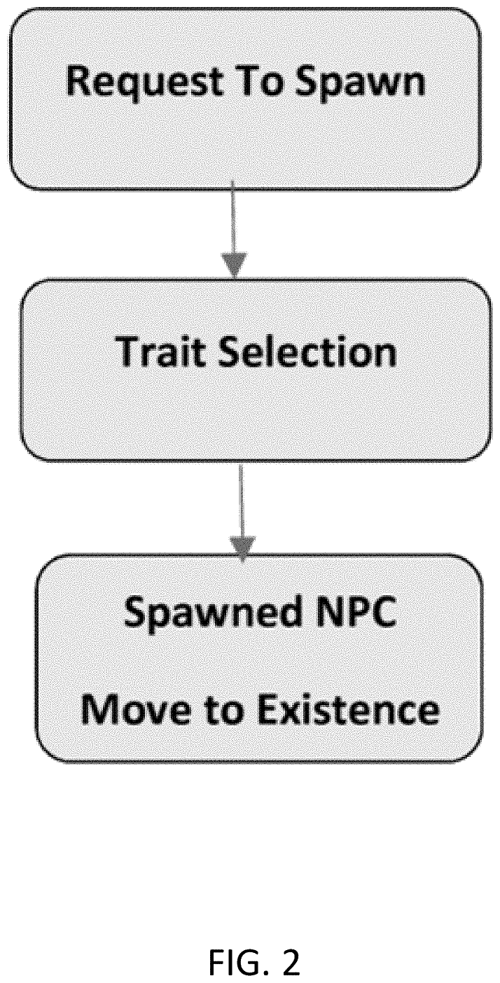

As shown in FIG. 2, when a request to create a new NPC 200 is made to the AI service 100, the AI service 100 creates the NPC 200 through a “birthing” algorithm that spawns NPCs 200 with programmed traits or “genetics” 102. Programmed genetics 102 can include unique traits that are the result of a trait selection algorithm which can range from simple to complex. The traits 102 are features of the NPC 200 program that, among other things, control the response of the NPC 200 to various virtual stimuli within. In a complex trait selection, traits can be analyzed and selected for their strengths or weaknesses, sometimes explicitly enforcing weaknesses in individual NPCs 200 that they must deal with through existence.

One example of unique trait selection by the AI service 100 could relate to the NPC's sensitivity to sensory inputs 112. An NPC 200 that is created by the AI service 100 can be programmed with the ability to sense, process, and store sensory inputs 112 from the existence service 110 or client interface 120. Sensory inputs 112 may include real and virtual inputs such as sight, sound, touch, taste, smell, time, a combination of the foregoing inputs, or any other sensory input 112 which an NPC 200 is programmed to sense. A set of NPC 200 unique sensory input 112 traits generated by the AI service 100 could include a strong sense of sight and sound, and no sense of smell or taste. Programmed genetics 102 can include other unique NPC 200 that can be modified by the AI service 100 for each NPC. Programmed genetics 102 and their effects on the NPC 200 and its learning process are discussed in more detail in embodiments below. After the NPC 200 is properly spawned and running it will be placed into the existence service 110.

Turning back to FIG. 1, NPCs 200 spawned by the AI Service 100 are shown within the existence service 110. The existence service 110 is a container service that can house one or more individual running NPCs 200 with connections to and from the game environment of the client interface 120. The existence service 110 exposes an NPC 200 to sensory inputs 112 from the game environment. Each NPC 200 is able to learn from the exposure to sensory inputs 112. NPCs 200 learn from sensory inputs 112 by processing the sensory inputs 112 into concepts 114 and storing the concepts 114 in memory. The existence service 110 can send individualized sensory inputs 112 to each NPC 200.

The existence service 110 can also enforce sensory inputs 112 across the entire existence service 110 creating a simultaneous sensory input 112 for multiple NPCs 200 at the same time. For example, the existence service 110 can stimulate visual, sound, and touch sensory inputs 112 for multiple NPCs 200 by simulating an earthquake, or a section of NPCs 200 within the existence service 110 at the same time. NPCs 200 can also receive sensory inputs 112 from the client interface 120. Sensory inputs 112 to the NPC 200 from the client interface 120 can override sensory inputs 112 from the existence service 110. The client interface 120 allows NPCs 200 to learn from sensory inputs 112 from users 202 or other NPCs 200 within the client interface 120. As indicated above, the client interface 120 may be any environment where users may interact with the NPCs 200, such as a video game platform that includes pre-programmed routines that produce sensory inputs 112 as well as sensory inputs 112 generated by users 202.

Importantly, the existence service 100 resides outside of the client interface 120, which allows the NPCs 200 to have a persistent existence that is not tied to the runtime of the client interface 120. This allows the programs running the NPCs 200 to evolve (or learn) by processing sensory inputs 112 over multiple instances of the client interface 120. For example, an NPC 200 that is stored in the existence service 100 can be connected to a series of different games, either in sequence or simultaneously, while maintaining the same experiential knowledge that has been acquired by the NPC 200 over previous game sessions. The ability to maintain a persistent existence for the NPC 200 allows the NPC 200 to evolve and improve as it gains experience through multiple, distinct game sessions.

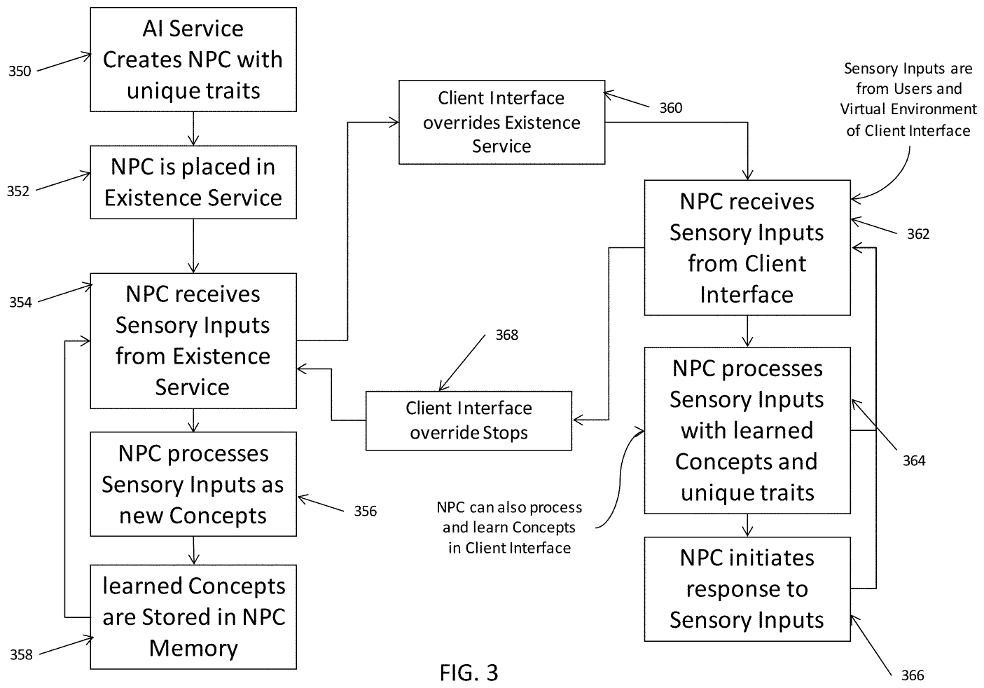

Turning now to FIG. 3, a process flowchart that provides an overview of interactions between the existence service 110 and the client interface 120 is shown. The process begins at step 350 by the AI service 100 creating an NPC 200 with unique traits and then placing the NPC 200 in the existence service 110 at step 352. At step 354, the NPC 200 is exposed to sensory inputs 112 within the existence service 110, which the NPC 200 processes into concepts 114 at step 356. At step 358, the NPC 200 stores the learned concepts 114 into its memory. The NPC 200 then senses another sensory input 112 and the process of learning concepts 114 repeats. This iterative learning process will repeat until the sensory inputs 112 from the existence service 110 to NPC 200 are stopped, or overridden by sensory inputs 112 obtained from the client interface 120.

For example, the sensory inputs 112 may be stopped by an action that impacts the ability of the NPC 200 to receive and process sensory inputs 112, by the NPC 200 being disconnected from the existence service 110, by the NPC 200 being destroyed, or by any other means sufficient to stop sensory inputs 112 from passing to the NPC 200 within the existence service 110. As shown in step 360, the sensory inputs 112 within the existence service 110 can be also overridden by sensory inputs 112 from the client interface 120. An override prioritizes the sensory inputs 112 from the client interface 120 over those from the existence service 110. The override can be triggered by any sensory input 112 from the client interface, a restricted set of sensory inputs 112 from the client interface 120 or any other means of sending an override trigger to the NPC. After the override, the NPC 200 processes the sensory inputs 112 from the client interface 120 in the same manner as sensory inputs 112 from the existence service 110. In step 362, NPC 200 is exposed to sensory inputs 112 which the NPC 200 processes into concepts 114 in step 364. The NPC 200 then stores concepts 114 that it learns into its memory. The NPC 200 then receives and processes another sensory input 112 and the process of learning concepts 114 repeats. As shown in step 366, the NPC 200 may also initiate a response to the sensory inputs 112 from the client interface. The NPC 200 may also initiate responses to the sensory inputs 112 within the existence service 110. The response from the NPC 200 in the client interface 120 however will be observed by other NPCs 200 and users within the client interface. As shown in step 368, when the client interface 120 override of the existence service 110 stops, the NPC 200 will return to receiving sensory inputs 112 from the existence service 110.

Sensory inputs 112 sensed by NPCs 200 are processed as concepts 114 by the NPC 200. Concepts 114 act as virtual neurons and include the elements of the sensory input 112 that the NPC 200 processed with a time element (t), which corresponds to when the NPC 200 sensed the sensory inputs 112. If an existence service 110 exposed an NPC 200 to a stimulus of a honking yellow car, the NPC 200 could process the sensory inputs 112 into a concept 114 comprised of the elements yellow color and car object at time t.

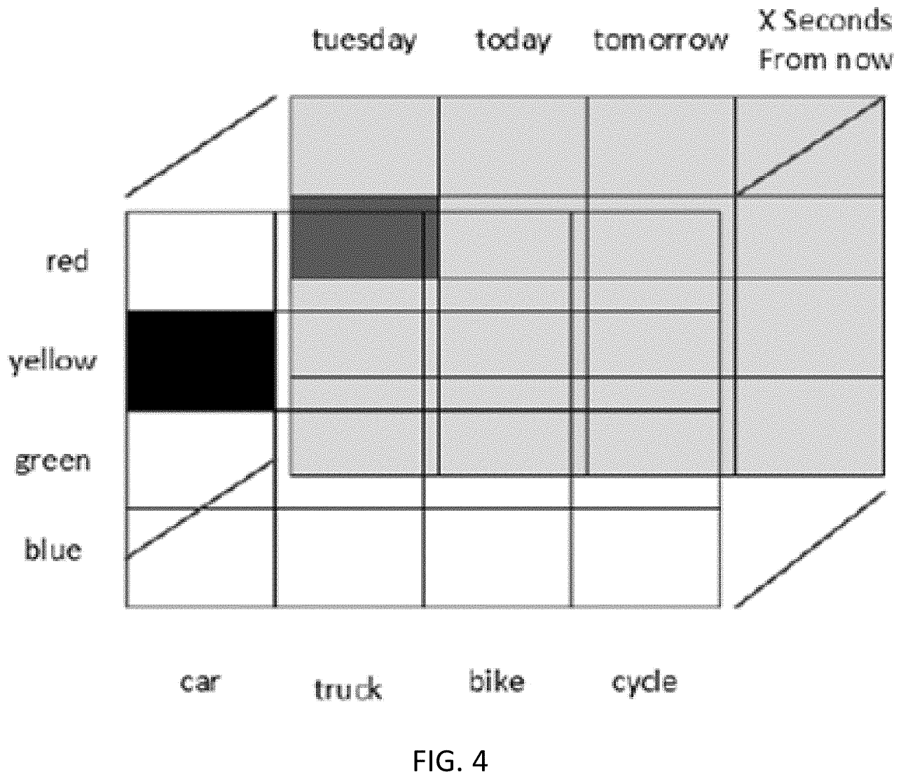

Turning to FIG. 4, a graphical representation of this concept 114 is shown. The concept 114 is shown with sensory input 112 occurring on a Tuesday, with a car-shaped object that is yellow. The various elements of a concept 114 are only limited in quantity and quality by the capacity of NPC 200 to receive and process the elements of sensory input 112. For example, if an existence service 110 later exposed an NPC 200 with the ability to see and hear to the same honking yellow car, the NPC 200 could process the sensory inputs 112 into a concept 114 comprised of the elements: yellow color, car shape and loud horn sound at time t+x.

In alternative embodiments, an NPC 200 may store each sensory element of the sensory input 112 as a separate concept 114. For instance, if an NPC 200 with the ability to see and hear is exposed to a honking yellow car, the NPC 200 could process the sensory inputs 112 into three separate concepts 114: a yellow color concept 114 at time t, a car shape concept 114 at time t, and a loud horn sound concept 114 at time t. In this manner, NPCs 200 with programmed genetics 102 and unique traits may learn unique concepts 114 from the same sensory input. Unique NPC 200 programmed genetics 102 and traits and the effects these have on NPC 200 learning are discussed further below.

Concepts 114 that are processed by NPCs 200 are hierarchically stored within the memory allocated to the NPC 200. The hierarchical storage of concepts 114 within the memory of the NPC 200 can depend upon elements of the sensory input 112 such as the frequency, intensity, and timing of the sensory input 112, as well as the sensory elements of sensory input 112 the concept 114 is based on. The frequency of the sensory input 112 refers to the number of times an NPC 200 has been exposed to the same concept 114 or a similar concept 114 with shared elements. The intensity of a sensory input 112 can refer to the qualities of the elements that make up the sensory input, such as the sharpness or size of an image, the strength of a touch, or the volume of a sound. The recency of a sensory input 112 refers to the amount of time that has passed since it was sensed. For instance, in reference to intensity, an NPC 200 could place the concept 114 based on the loud honking yellow car higher in a memory hierarchy than a quiet honking yellow car.

In reference to the temporal aspects of a sensory input 112, an NPC 200 with similar traits who has been more recently exposed to same sensory input, could place the “the honking yellow car” concept 114 higher in the memory hierarchy. In reference to frequency, an NPC 200 with similar traits who has been repeatedly been exposed to same sensory input 112 may place the concept 114 higher in the memory hierarchy. The factors that decide the placement of a concept 114 in an NPC's memory hierarchy can overlap and have different weights in determining the placement of the concept 114 memory hierarchy. The weight of a factor may be set by the AI service 100 as a programmed genetic or learned by the NPC.

The hierarchical storage of concepts 114 within the NPC's memory can also depend upon the programmed genetics 102 of the NPC. NPC 200 programmed genetics 102 are unique traits that NPCs 200 are created with by the AI service 100. The AI service 100 can give an NPC 200 unique traits, by modifying how NPC 200 senses sensory inputs 112, and processes and stores those inputs as concepts 114. NPC 200 programmed genetics 102 may include an NPC's ability to sense certain types of sensory inputs 112 or their sensitivity to certain types of sensory inputs 112, as previously discussed. By way of example, some NPC 200 programmed genetics 102 related to sensory inputs 112 may include: a more or less sensitive sense of sights, sounds, physical touch, smells, tastes; a more or less accurate sense of time; or the ability to only process certain types of input. For instance, an NPC 200 that is programmed to have a good sense of hearing or sensitivity to loud noises, could place the honking yellow car concept 114 high in a memory hierarchy. An NPC 200 with a high sensitivity to time may separate concepts 114 within the memory hierarchy based on concepts 114 having very small differences in their time elements, that another NPC 200 may associate with the same time element. An NPC 200 that is programmed with a goal of finding yellow objects could place the concept 114 based on the honking yellow car high in a memory hierarchy. In addition, an NPC's sensitivity to certain senses can also be programmed to be specific within that sense. By way of example, an NPC 200 may be sensitive to a certain type of touch (very hot or very cold) or only in a certain area (right arm more sensitive than left arm). For instance, an NPC 200 could place the concept 114 based on a touch to the right arm higher in a memory hierarchy than a touch to the left arm, because that touch is more intense.

Programmed genetics 102 may also include goals programmed into NPCs 200. Through programmed goals, NPCs 200 may be rewarded or punished for recognizing or interacting with certain sensory inputs 112. By way of example, an NPC 200 may gain or receive health points for sensing a certain sensory input. A different NPC 200 may receive no effect to health points from the same sensory input 112 and may place the concept 114 based on the sensory input 112 lower in the memory storage hierarchy.

The hierarchical storage of concepts 114 within the NPC's memory can also depend upon the NPC's stored concepts 116. Stored concepts 116 are concepts 114 that are the NPC 200 has previously learned through processing sensory inputs 112 or that the NPC 200 was programmed with by the AI service 100. When an NPC 200 processes a new concept, stored concepts 116 which are similar to the new concept 114 are recalled by the NPC. This recall creates a relationship between the new concept 114 and the similar stored concepts 116. If the related stored concepts 116 are placed high into memory storage hierarchy, the new concept 114 will also be more likely to be placed high in the memory storage hierarchy as well.

As shown in the examples above, the AI service 100 can create NPCs 200 with many variations to programmed genetics 102. The variations in programmed genetics discussed above can affect how different NPCs 200 process and store the same sensory input 112 into concepts 114 in the NPC's memory storage hierarchy. Most examples above show how one difference to programmed genetics 102 can affect the processing and storage of concepts 114. It should be understood that multiple modifications to an NPC's 200 programmed genetics 102 can have an overlapping effect on the how NPCs 200 learn.

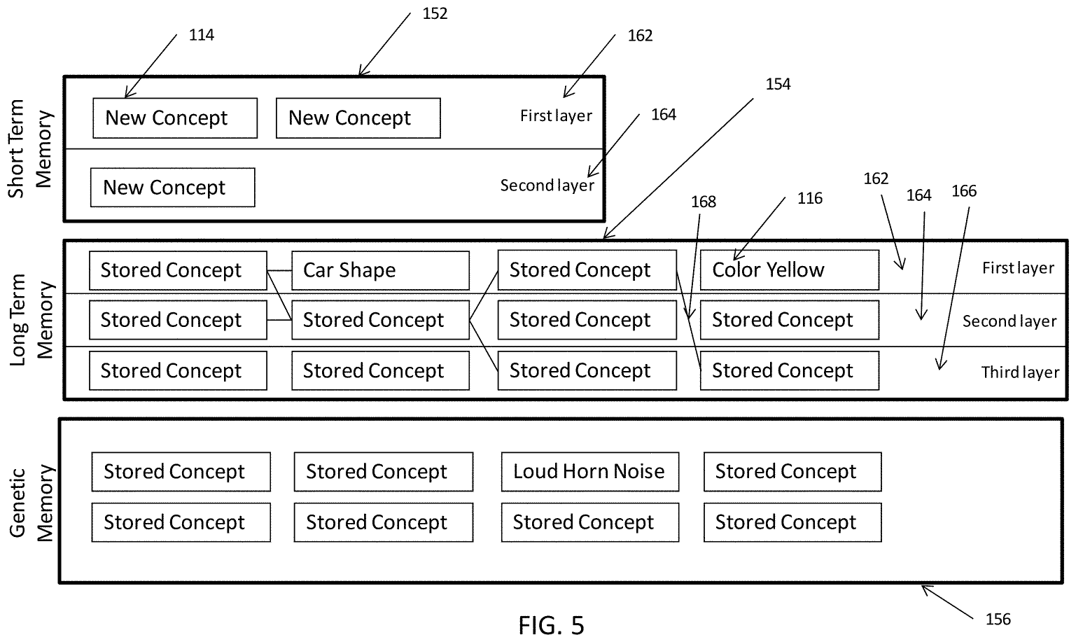

Turning now to FIG. 5, a graphical depiction showing an embodiment of a memory 150 assigned to the NPC 200. The memory 150 is multi-layered and configured for the hierarchal storage of concepts 114. The memory storage hierarchy includes three layers: short term memory 152, long term memory 154 and genetic memory 156. In other embodiments NPC 200 memory may comprise more or less layers beyond short term memory, long term memory, and genetic memory. Each layer within the memory storage hierarchy may also include additional hierarchical layers.

Short term memory 152 is used by the NPC 200 to temporarily hold concepts 114 that have been processed. The amount of time that new concepts 114 can be held in short term memory 152 can be limited through programmed genetics 102. The number of concepts 114 that can be stored in short term memory 152 can also be limited through programmed genetics 102. Short term memory 152 can also restricted in other ways to limit the number of concepts 114 that may be temporarily help in short term memory. Long term memory 154 is where learned or stored concepts 116 are held. Concepts 114 in long term memory 154 have been taken from short term memory.

The criterion for committing a concept 114 to long term memory 154 is that the concept 114 meets a stored concept threshold 158 of the NPC. The stored concept threshold 158 is a threshold that can depend upon an NPC's programmed genetics 102. The stored concept threshold 158 determines the relevancy of a concept 114 based on the elements of the concept. A concept 114 that meets the stored concept threshold 158 may be one that has been repeatedly reinforced and is “easily recognized” by the NPC 200 from training that occurred in short term memory, or that the concept's intensity (impact or weight via trauma or reward) is so high that it requires committing it immediately to long term memory.

Genetic memory 156 is composed of concepts 114 that were created and placed in the NPC's memory by the AI service 100 when the NPC 200 was created. Concepts 114 held in genetic memory 156 serve a similar role to concepts 114 stored in long term memory. The main difference between the two layers is that concepts 114 in genetic memory 156 are ingrained or programmed into the NPC 200 and concepts 114 in long term memory 154 are learned.

The hierarchical layers of memory 150 allow the NPC 200 to prioritize and organize concepts 114. As discussed above the placement of a concept 114 within the memory storage hierarchy is dependent upon the elements of the sensory input 112 and the NPC's programmed genetics 102. In FIG. 5 long term memory 154 is shown with a first hierarchical layer 162, a second hierarchical layer 164 and a third hierarchical layer 166. Stored concepts 116 held in higher layers of NPC 200 memory are concepts 114 that the NPC 200 prioritizes based on the NPC's programmed generics or previously stored concepts 116 as discussed above. Short term memory 152 is shown with similar first and second hierarchical layers. In addition, other memory layers may also comprise hierarchical layers to organize concepts 114 held within the memory layer. Also shown in FIG. 5, the stored concepts 116 within long term memory 154 are shown with connections 168 to other stored concepts 116. The connections 168 show that a stored concept 116 has an element in common with the connected stored concepts 116. The connection 168 is created when the NPC 200 processes a sensory input 112 into a new concept.

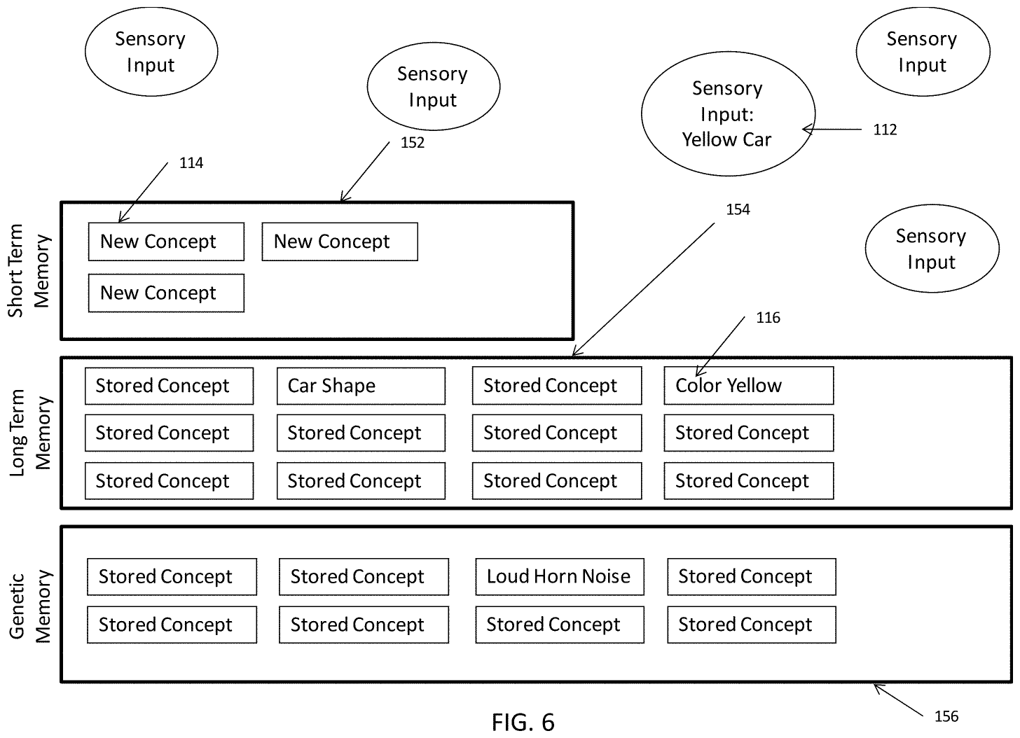

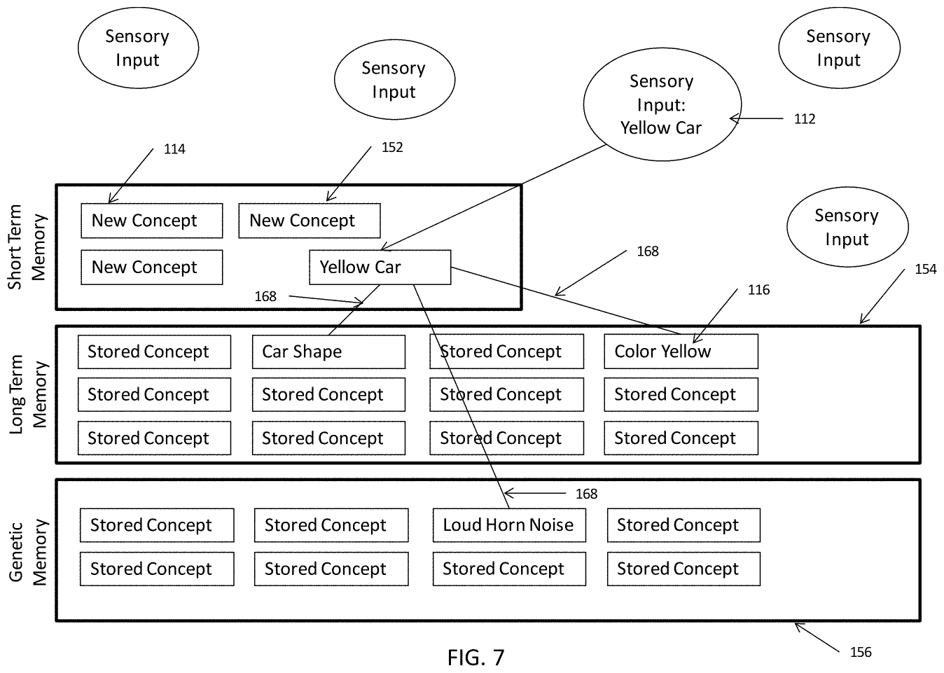

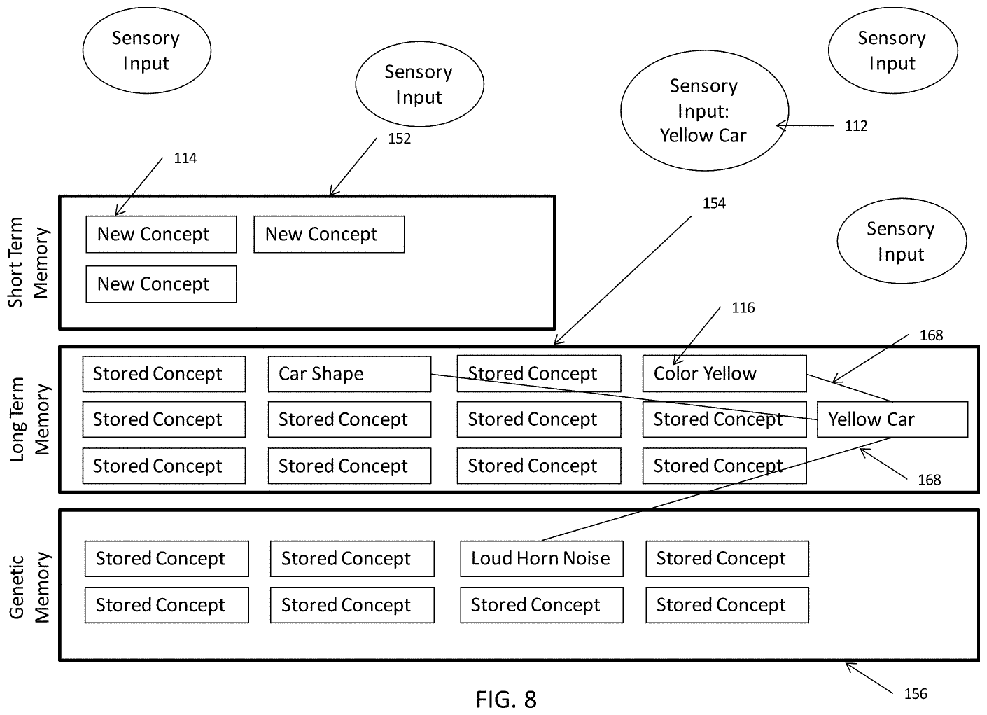

Turning to FIGS. 6-8 the process for the creation of the connection 168 between stored concepts 116 is shown. In FIG. 6, a graphical depiction showing an NPC 200 hierarchical system for storing concept 114 prior to processing a set of sensory inputs 112 is shown. In FIG. 7, the NPC 200 processes the sensory input 112 associated with a yellow car into a concept 114 and holds the new concept 114 in short term memory 152. When the new concept 114 is created, the NPC 200 can be configured to create connections 168 to stored concepts 116 in other hierarchical layers of the memory 150 with similar elements. Here the new concept 114 is shown with connections 168 created to stored concepts 116 in long term memory for a car shape, a yellow car and genetic memory 156 for a loud horn noise. Turning now to FIG. 8, a new concept 114 is shown being moved into long term memory 154. If the new concept 114 meets the stored concept threshold 158, the new concept 114 is stored in long term memory 154 as a stored concept 116 with the connection 168 to related stored concepts 116.

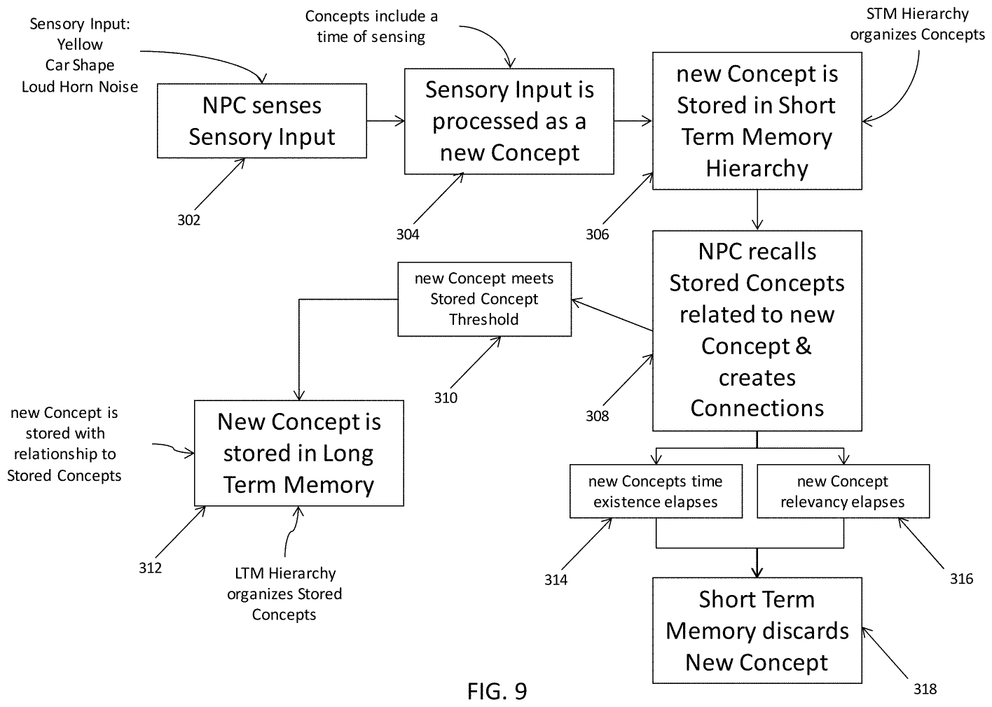

Turning now to FIG. 9, a process flowchart showing an overview of an embodiment of a method of how an NPC 200 processes sensory inputs 112. The method includes a number of different steps and it will be appreciated that some of the steps may be optional and the order of steps may be changed depending on the requirements of a particular application. It will be further observed that the method may be iterative and may include multiple end points. In the process, a sensory input 112 is produced by an existence service 110 or client interface 120. In step 302, an NPC 200 senses the sensory input 112 comprising the elements of the color yellow, the shape of a car and a loud horn noise. In step 304, The NPC 200 processes the sensory input 112 as a new concept 114 with a time of sensing t. In step 306, the new concept 114 is then held in the short term memory 152 and organized by the NPC 200 into a memory hierarchy. In step 308, stored concepts 116 which share similar elements to the new concept 114 are then recalled by the NPC 200. The NPC 200 then creates connections 168 between the new concept 114 and the similar recalled stored concepts 116. If the new concept 114 meets the stored concept threshold 158 in step 310, then in step 312 the new concept 114 is stored in long term memory 154 as a stored concept 116. The new concept 114 will be stored with the connections 168 to other stored concepts 116 and organized into the long term memory 154 hierarchy. If the new concept 114 is later recalled by the NPC 200 these connections 168 may also allow the NPC 200 to recall the similar stored concepts 116 as well through the connections 168. If the new concept 114 does not meet the stored concept threshold 158, then the new concept 114 remains in short term memory 152. The concept 114 may later be moved into long term memory 154 by reinforcement of the same concept 114 or other means which change the relevancy of the new concept 114 to the stored concept threshold. The new concept 114 may also be moved out of short term memory 152 in step 314 if the new concept 114 exceeds the amount of time that new concepts 114 can be held in NPC's short term memory 152 by programmed genetics 102. The new concept 114 may also be moved out of short term memory 152 in step 316 if the number of concepts 114 that can be stored in short term memory 152 is limited through programmed genetics 102 and the new concept 114 is the least relevant of those stored in short term memory. The least relevant concept 114 may refer to the concept 114 that has the lowest position in the short term memory 152 hierarchy. As discussed above, the placement of a concept 114 within the memory hierarchy and therefore, the relevancy of a concept, may be determined by the elements of the sensory input 112 that the concept 114 is based on and the programmed genetics 102 of the NPC. If the new concept 114 is moved out of short term memory 152, in step 318 it is effectively discarded by the NPC 200 as the concept 114 cannot be later recalled. If the concept 114 is discarded then the connections 168 to the stored concepts 116 are also discarded.

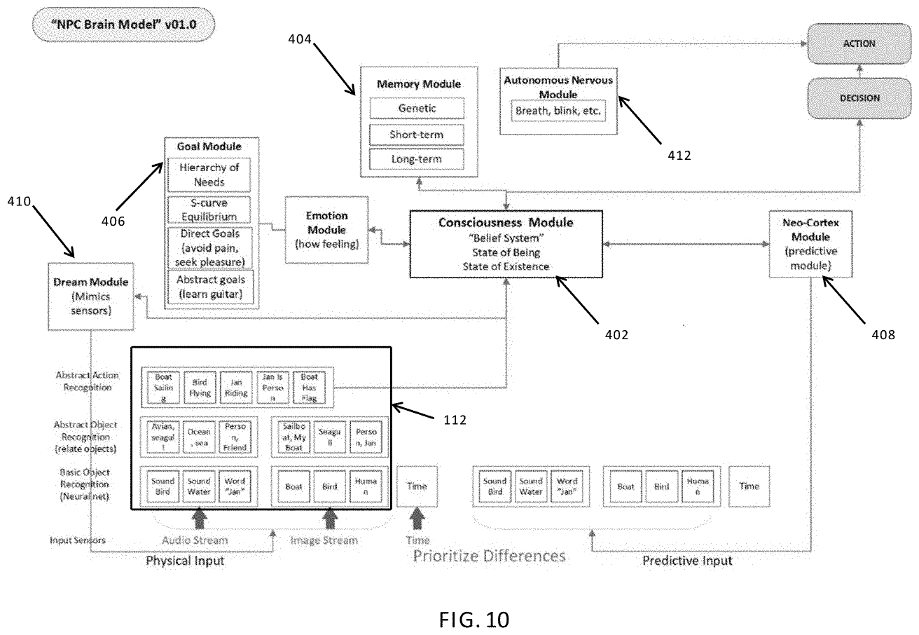

Turning to FIG. 10, shown therein is a graphical depiction of an embodiment of an NPC computer-implemented conceptual processor (“brain”). The NPC brain shows the connections between multiple modules that comprise the NPC's brain. In other embodiments, the NPC brain may comprise more or less modules. In FIG. 10, a consciousness module 402 is shown which is in communication with a memory module 404, sensory inputs 112, a goal module 406, a neo-cortex module 408, and a dream module 410. The memory module 404 contains the hierarchical memory layers of genetic memory 156, short term memory 152 and long term memory 154. The goal module 406 contains goals that can be created by the AI service 100 as a programmed genetic 102 or learned by the NPC 200. Sensory inputs 112 are sensed from an existence service 110 or client interface 120 and processed by the consciousness module 402 into the memory module 404. The neo-cortex module 408 allows the NPC 200 to predict the outcome of sensory inputs 112 it is processing based on programmed genetics 102 and concepts 114 in its memory module 404. By way of example, an NPC 200 may be able to predict the outcome from a sensory input 112 it has experienced before and then make a decision based on the predicted outcome. These predictions could be based on the connections 168 between concepts 114 within the memory module 404. The dream module 410 allows the NPC 200 to recall concepts 114 stored in the memory module 404. The recall of these concepts 114 can be used by the NPC 200 to reinforce the concepts 114 and connections 168 between the concepts 114.

The consciousness module 402 decides what actions an NPC 200 should take through communication with the other modules and initiates those actions. NPC 200 actions may include initiating response actions that produce sensory outputs 118 to users 202 or a virtual environment, such as creating visuals, making sounds, initiating contact, presenting tastes or smells. NPC 200 action may also include deciding which sensory input 112 to process. NPC 200 actions can also include any other action which an NPC 200 can be programed to initiate. Some NPC 200 actions can be out of the control of the consciousness module 402. These actions, such as the NPC's breathing or blinking are controlled by the autonomous nervous module 412. Actions that an NPC 200 decides to take are based on the goals of the NPC 200 stored in the goal module 406.

NPCs 200 can have one or more goals, for example gathering coins and retaining health. NPC 200 goals may be programmed into the NPC 200 by the AI service 100. Goals programmed into the NPC 200 can be based on direct goals 417, for example seeking out food or energy sources, or avoiding pain and seeking out pleasure. Goals that the NPC 200 is programmed with can also be abstract goals 415 such as finding other NPCs 200 and users 202 or learning to play guitar. NPC 200 goals may be also prioritized. Prioritization of goals can be programmed or an NPC 200 may decide the priority of its goals based on its current state. The state of an NPC 200 can correlate to the sensory inputs 112 the NPC 200 has recently processed or interacted with.

An NPC 200 can be presented with more than one input 112 at a given time. Simple virtual environments or simple interactions with other NPC 200 or human characters can have numerous associated sensory inputs 112. The NPC 200 therefore will need to decide which inputs to interact with first. This decision is another form of action by the NPC. The NPC 200 can decide which sensory inputs 112 to interact with first by prioritizing the available sensory inputs 112. NPC 200 sensory input 112 prioritization can be based off the elements of the sensory input, the goals of the NPC, the relationship between the sensory input 112 and stored concepts 116 in the NPC's memory, the NPC's hierarchical system of concept 114 storage, and the programmed genetics 102 of the NPC.

Actions of an NPC 200 can also be predictive based on relationships between stored concepts 116 and new concepts 114. For example, the NPC 200 senses and processes a new concept 114 comprising the elements of a guitar and speaker with no connection between. The NPC 200 then recalls the stored concept 116 of guitar and speaker with no connection. The NPC 200 may recall related stored concepts 116 with a later time element of the same guitar and speaker with connection and a loud sound. Based on the strength of the relationship between the new concept 114 and stored concepts 116, the NPC 200 may predict that there will be a loud noise with the guitar and speaker with no connection or that there will not be a loud noise with the guitar and speaker with no connection. The NPC 200 can initiate an action based on the prediction such as blocking sound inputs or covering its ears.

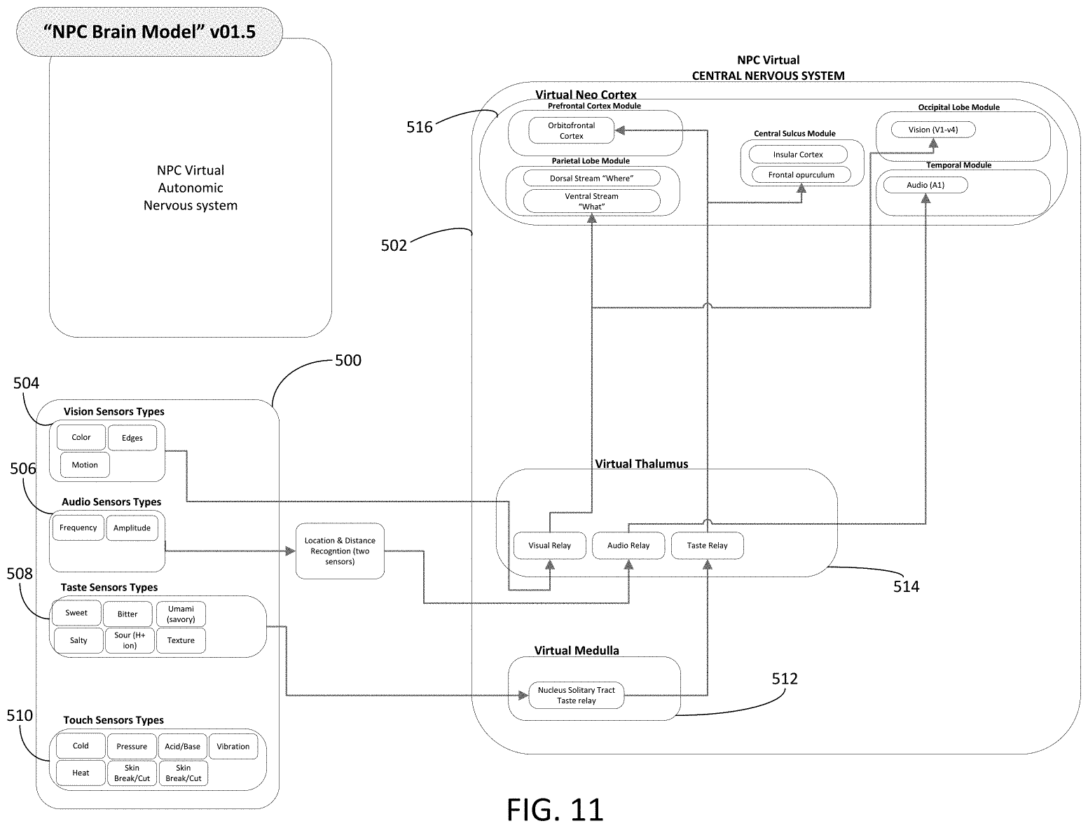

As depicted in FIG. 11, shown therein is a graphical depiction of an embodiment of an NPC autonomous or semiautonomous control system in which external sensors 500 are configured to provide virtualized sensory feedback to a central nervous system 502. In this embodiment, the NPC cognitive and reflexive engine (e.g, the “NPC brain”) is closely modeled on the mammalian peripheral and central nervous system structures and functions. The cognitive and reflexive engine can be configured for the operation of the computer-implemented NPC 200, or for the operation of a physical robot 204.

The external sensors 500 may be categorized based on fundamental sensory mechanisms, which may include vision sensors 504, audio sensors 506, taste sensors 508 and touch sensors 510. In each case, these sensors 500 are configured to register the presence, quantity, and quality of appropriate stimuli in the virtual environment surrounding or in contact with the NPC. In response to contact with an external stimulus, e.g., a siren noise broadcast in the vicinity of the NPC, the external sensors 500 that are configured to register that stimulus, e.g., the audio sensors 506, output an appropriate stimulus detection signal that is passed to the appropriate processors within central nervous system 502.

The central nervous system 502 may include a virtual medulla 512 configured to receive certain stimulus detection signals (e.g., taste detection signals), while a virtual thalamus 514 is configured to receive other stimulus detection signals (e.g., video and audio detection signals). The virtual medulla 512 and virtual thalamus 514 are configured to identify the stimulus detection signals, provide a first level of processing, and then direct those signals to an appropriate second level processing available in a virtual neo cortex 516.

The virtual neo cortex 516 includes a pre-fontal cortex module 518, a parietal lobe module 520, a central sulcus module 522, an occipital lobe module 524 and a temporal module 526. Each of these separate processing modules is configured to receive, process and respond to one or more signals presented directly or indirectly from the external sensors 500. It will be appreciated that the modules within the NPC brain have been presented as separate components within a larger neural architecture, but these “modules” can be functionally and structurally present within combined processing and memory resources within the computing system. Thus, the depiction of these modules as discrete elements is for illustration and explanatory purposes and the working embodiment of these features can be presented as a software-enabled processes carried out on shared or common computer processing systems.

Although the external sensors 500 are configured to provide virtualized sensory feedback to a central nervous system 502 in response to virtual stimuli within a computer-generated environment, the same neural architecture can also be applied to autonomous and semi-autonomous robots in the physical world. In these embodiments, the cognitive and reflexive engine is used by the robot 204 to perceive, process and respond to actual stimuli encountered by the robot 204.

The robot 204 can be equipped with distributed sensors (including, but not limited to, touch sensors, cameras, microphones, vibration sensors, and thermometers) that are each configured to produce a stimuli detection signal in response to an actual, real-world external stimulus. The robot 204 can be provided with computer processors and programming to receive, process and respond to the stimuli detection signals. The processors can be functionally arranged according to the general architecture of the central nervous system 502. Thus, the same system that is configured to provide stimuli-responsive intelligence to a virtual NPC can also be adapted for use in autonomous robots.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept.

It is claimed:

1. A software-enabled neural processing system for a non-player character (NPC) in a computer-enabled virtual environment, the neural processing system comprising:
a plurality of virtual sensors, wherein each of the plurality of virtual sensors is configured to detect one or more virtual stimuli presented by the virtual environment to the NPC and present corresponding stimuli detection signals in response to the one or more virtual stimuli;
a virtual neo cortex, wherein the virtual neo cortex includes a plurality of processing modules that each configured to process stimuli detection signals output from the plurality of virtual sensors; and
a virtual thalamus module configured to receive the stimuli detection signals and transmit the stimuli detection signals to the appropriate processing modules of the virtual neo cortex.

2. A software-enabled method for controlling an adaptive non-player character (NPC) program in a computer-enabled video game environment, the software-enabled method comprising the steps of:
spawning the adaptive NPC with a series of character traits;
moving the spawned adaptive NPC to an existence server;
connecting the adaptive NPC from the existence server to a first game session within the video game environment;
modifying the adaptive NPC in response to a stimulus from the first game session to produce a modified adaptive NPC;
terminating the first game session while maintaining the modified adaptive NPC in a persistent state within the existence server; and
connecting the modified adaptive NPC from the existence server to a second game session within the video game environment.

3. A software-enabled neural processing system for a physical robot, the neural processing system comprising:
a plurality of sensors, wherein each of the plurality of virtual sensors is configured to detect one or more stimuli presented by to the robot from an environment surrounding the robot, and present corresponding stimuli detection signals in response to the one or more stimuli;
a software-enabled artificial neo cortex, wherein the artificial neo cortex includes a plurality of processing modules that each configured to process stimuli detection signals output from the plurality of sensors; and
a software-enabled artificial thalamus module configured to receive the stimuli detection signals and transmit the stimuli detection signals to the appropriate processing modules of the artificial neo cortex.
